(19) United States
(12) Patent Application Publication
(10) Pub. No.: US 2020/0252022 A1
(43) Pub. Date: Aug. 6, 2020

(54) DEPLOYABLE SOLAR GENERATOR MODULE AND SYSTEM

(71) Applicant: Smart Blox Pty Ltd, Red Hill, Brisbane, Queensland (AU)

(72) Inventor: Timothy James Larsen, Canberra (AU)

(21) Appl. No.: 16/639,260

(22) PCT Filed: Aug. 14, 2018
(86) PCT No.: PCT/AU2018/050861

§ 371 Date: Feb. 14, 2020

(30) Foreign Application Priority Data
Aug. 14, 2017 (AU) 2017903255

(51) Int. Cl. H02S 10/40; H02S 30/20; H02S 40/32; H02S 40/36; H02S 40/38; H02J 7/35; H02J 7/02

(52) U.S. Cl. CPC H02S 10/40; H02S 30/20; H02S 40/32; H02J 7/02; H02S 40/38; H02J 7/35; H02S 40/36

(57) ABSTRACT

A solar generator module (200) for manual deployment, the module comprising: at least one photovoltaic solar panel (201) forming an array of solar cells having a perimeter; a solar panel interface unit (302) receiving a DC supply from the at least one solar panel; at least one energy storage battery (336) coupled to the interface unit; a battery management sub-system (303, 305) coupled to the storage battery; a DC-AC inverter (324) having an input coupled to the storage battery; and at least one protected AC outlet receptacle (327) fed via an AC bus from an output of the DC-AC inverter (324); wherein the solar panel array, interface unit, energy storage battery, battery management sub-system, inverter and AC outlet receptacle are integrated into a unitary package (280); the unitary package including a rugged frame (284) and an outer casing (290) associated with the frame and substantially surrounding the perimeter of said array of solar cells, the casing (290) having side faces (292) with an engagement formation (286, 288) that can be releasably attached to an opposing casing side face of an adjacent solar generator module.

### TECHNICAL FIELD

The present invention finds application in the renewable energy sector, specifically involving the generation and storage of electrical energy from natural phenomena including solar radiation, specifically using photovoltaic cells for direct conversion into electrical energy.

### BACKGROUND OF THE INVENTION

There exist a number of key technical problems presently available photovoltaic solar energy systems, particularly where desired to be used in remote areas or as back-up power supplies by individuals, as follows:

Complexity: Existing photovoltaic systems are relatively complex requiring multiple separate components to be installed by technicians in order to provide electrical power for residential, commercial and/or light industrial use. This complexity and installation requirement impedes convenient access to solar photovoltaic technology, particularly by non-qualified end users. A petrol engine powered generator that outputs residential power (e.g. 240 volt alternating current power through a general purpose type outlet) can typically be conveniently purchased from a local hardware store. In contrast to known solar PV installations, the petrol generator and associated power management system are provided a single product that outputs residential power and is generally safe for the average person to use upon adhering to operating instructions.

Scalability: Existing solar photovoltaic systems for domestic or commercial use, although inherently scalable in design, are typically fixed to a building or similar structure, such as a shipping container or trailer, once installed. Extra generating capacity cannot be simply added by end users, and certainly not without re-considering all technical aspects of the system including: mounting, wiring, inverter sizing, together with battery sizing, battery management (where provided) and protection sub-systems. In the alternative, small scale solar PV systems, are generally only capable of powering hand-held devices such as mobile telephones or tablets which consume only 5v DC and typically utilise four (4) 1.5v rechargeable dry-cell batteries.

Deployability: Solar photovoltaic systems are also relatively delicate and need to be carefully transported to avoid damage, they also take time to install and setup. By contrast, a petrol engine powered generator can be up and running by an individual, for example to provide stand-by power, within minutes. A disadvantage of petrol generators is the requirement for careful handling and safe storage of volatile liquid fuels.

Portability: Whilst the prior art includes mobile solar generation plant, typically carried in containers and/or by semi-trailers or ships, there are characterised by a much larger energy generation and storage capacity than required by an individual domestic or small commercial user, and are very bulky resulting in the same installation issues applying to fixed solar installations and accompanied by very high transportation costs and attendant inherent unsuitability for manual deployment. The modular photovoltaic light and power cube provided in a containerized enclosure and including a telescoping mast for lighting sports grounds, as disclosed in International Publication No. WO 2017/083687 A1, is typical of such large scale solar generation plant.

Any references to methods, apparatus or documents of the prior art are not to be taken as constituting any evidence or admission that they formed, or form part of the common general knowledge in the technical field of the invention, whether in Australia or any other country.

### SUMMARY OF THE INVENTION

In a first embodiment of the invention, there is provided a deployable solar generator module comprising:
at least one photovoltaic solar panel forming an array of solar cells having a perimeter;
a solar panel interface unit receiving a DC supply from the at least one solar panel;
at least one energy storage battery coupled to the interface unit;
a battery management sub-system coupled to the storage battery;
a DC-AC inverter having an input coupled to the storage battery; and
at least one protected AC outlet receptacle fed via an AC bus from an output of the DC-AC inverter;
   wherein the solar array, interface unit, energy storage battery, battery management sub-system, inverter and AC outlet receptacle are integrated into a unitary package;
the unitary package including a rugged frame and an outer casing associated with the frame and substantially surrounding the perimeter of said array of solar cells, the casing having side faces with an engagement formation whereby the unitary package can be releasably attached to and locked in place with an opposing casing side face of an adjacent solar generator module.

Preferably the rugged frame provides shock resistant mounting of the integrated components and the outer casing is configured to allow vertical stacking for transport and/or storage purposes.

The solar generator module according to either claim 1 or claim 2 wherein the casing houses a mounting structure for supporting the solar generator module in a desired position or for manual handling.

The mounting structure may include adjustable legs pivotally mounted to the rugged frame, each leg including a foot adapted to be fixed to a support surface. Suitably, the mounting structure includes handles provided on front and/or rear faces of the outer casing. If requires the mounting structure may include wheel members or rollers provided on end or side faces of the outer casing.

Preferably the engagement formation includes a plurality of protrusions and/or a plurality of complementary recesses on opposing side faces of the outer casing. The protrusions may include a pair of tubular members and the recesses comprise sockets adapted to receive the tubular members of an adjacent solar generator module. Alternatively, the protrusions and recesses may be in the form of castellated housing sections, wherein the castellated section on a first side face of the outer casing is complementary to the castellated section on a second side face of the outer casing.

The faces of the outer casing preferably include electrical connectors for electrically linking adjacent modules together. The electrical linking of adjacent generator modules suitably includes provision of a common AC bus for linked modules.

The electrical connectors may include an electrical plug and an electrical receptacle provided on first and second side faces of the outer casing, respectively. The electrical connectors may be provided on first and second side faces of the outer casing, with electrical cabling associated with the connectors being housed in an outer sleeve. Suitably, an assembly of the electrical connectors and a strong resilient outer sleeve provides electrical links between adjacent modules and assists in attaching the modules to one another.

Preferably operation of the interface unit, energy storage battery, battery management sub-system and inverter are coordinated by a main control unit (MCU) housed within the integrated package. Suitably the MCU communicates with adjacent modules via a common data bus, and said electrical connectors further include connectors for a common data bus for linking modules.

The solar generator module may further include a rectifier for selectively charging the energy storage battery from the AC bus, under control of the MCU.

The MCU is suitably arranged to detect electrical connection of an adjacent solar generator module and synchronise the use of the solar PV array and storage battery in the adjacent module, together with any AC voltage present on the AC bus. The MCU may also be provided with sensing lines associated with both AC bus connectors and/or data bas connectors on each of the first and second side faces of the outer casing.

In another aspect of the invention, there is provided a solar generator system comprising a plurality of linked solar generator modules according to the above statements in the summary of the invention.

In yet another aspect of the invention there is provided a method for managing the use and storage of electrical energy in a deployable solar generator module according to the above statements, the method comprising the steps of:
detecting charge state of the at least one energy storage battery; and
charging the battery from any excess available supply from the inverter and/or from an external DC supply.

The solar generator management method may further include charging the battery utilising the rectifier from the AC bus utilising AC voltage present on the AC bus and/or from an external AC supply. Suitably, the presence of any external source of AC supply, such as from an adjacent solar generator module, is detected on the AC bus by the MCU.

In yet another aspect of the invention, there is provided a solar generator system comprising a plurality of linked solar generator modules according to the above statements when operated in accordance with the method set out immediately above.

In a further aspect of the present invention, there is provided a fluid energy generator module for manual deployment, the module comprising:
at least one propeller or impellor driven by fluid flow and coupled to a generator for producing electrical supply;
a generator interface unit receiving electrical energy from the generator;
at least one energy storage battery coupled to the interface unit;
a battery management sub-system coupled to the storage battery;
a DC-AC inverter having an input coupled to the storage battery; and
at least one protected AC outlet receptacle fed via an AC bus from an output of the DC-AC inverter;
   wherein the propeller or impellor drive, interface unit, energy storage battery, battery management sub-system, inverter and AC outlet receptacle are integrated into a unitary package;
the unitary package including a rugged frame and an outer casing associated with the frame and substantially surrounding the perimeter of said propeller or impellor drive, the casing having side faces with an engagement formation that can be releasably attached to an opposing casing side face of an adjacent fluid energy generator module.

In one form of the foregoing fluid energy energy storage module, said at least one propeller or impellor may comprises a wind turbine. In one form of the foregoing fluid energy energy storage module said at least one propeller or impellor comprises a wind turbine.

### BRIEF DETAILS OF THE DRAWINGS

Preferred features, embodiments and variations of the invention may be discerned from the following Detailed Description which provides sufficient information for those skilled in the art to perform the invention. The Detailed Description of embodiments is not to be regarded as limiting the scope of the preceding Summary of the Invention in any way.

The Detailed Description will make reference to a number of drawings of preferred embodiments, as follows:

FIG. 1 is a top perspective view of single solar generator module 100 of a first embodiment, having a back plate mounted battery;

FIG. 2 is a top perspective view of a single solar generator module 100′ of a minor variant of the first embodiment, wherein the battery is top mounted;

FIG. 3 is a top perspective view of a stack of a plurality of solar generator modules of the first embodiment in a storage configuration;

FIG. 4 is a front end phantom view of the solar generator module of FIG. 1;

FIG. 5 is a rear end phantom view of the solar generator module of FIG. 1;

FIG. 6 is a bottom or back view of the solar generator module of FIG. 1 showing the battery and other components associated with solar PV cells;

FIG. 7 is a rear view of the solar generator module of FIG. 1 in an deployed configuration, elevated on support members;

FIG. 8 is a left side perspective view of the deployed solar generator module of FIG. 7;

FIG. 9 is a right side perspective view of the deployed solar generator module of FIG. 7;

FIG. 10 is a front perspective view of a series or chain of solar generator modules 100.1, 100.2, 100.3 of FIG. 7 that are coupled to one another in a solar generator system of a first embodiment of the invention;

FIG. 11 is an enlarged fragmentary view of a portion “B” of the solar generator module of FIG. 9 showing an electrical receptacle and coupling spigot on a left side face of the module;

FIG. 12 is an enlarged fragmentary view of a portion “A” of the solar generator module of FIG. 8 showing an electrical plug and coupling socket on a right side face of the module;

FIG. 13 is a block diagram of the main circuit components of the solar generator module, as shown in FIGS. 6 and 7;

FIG. 14 is a top orthogonal view of a single solar generator module 200 of a second embodiment of the invention;

FIG. 15 is a rear end view of the solar generator module of FIG. 14, with the addition of a further pair of wheels to the rear end handles;

FIG. 16 is a top plan view of the solar generator module of FIG. 14;

FIG. 17 is a front end view of the solar generator module of FIG. 14;

FIG. 18 is a right side view of the solar generator module of FIG. 14;

FIG. 19 is a left side view of the solar generator module of FIG. 14;

FIG. 20 is a bottom or back view of the solar generator module of FIG. 14, showing back mounted components;

FIG. 21 is a top orthogonal view of a stack of a plurality of solar generator modules of the second embodiment;

FIG. 22 is an exploded perspective view of the solar generator module of FIG. 14;

FIG. 23 is a top orthogonal view of a shell or hosing of the solar generator module of FIG. 14, from which solar panel/s have been removed;

FIG. 23C is a fragmentary exploded view of the shell of FIG. 23, showing fitment of supporting wheels;

FIG. 24 is a front perspective view of a further solar generator system employing a plurality of interconnected solar generator modules of the second embodiment in FIG. 14;

FIG. 25 is a front phantom view of the solar generator system of FIG. 24 showing the location of several module coupling links;

FIG. 25A is an enlarged fragmentary front phantom view of the generator system of FIG. 25 showing a first module coupling link in a first position;

FIG. 25B is an enlarged fragmentary front phantom view of the generator system of FIG. 25 showing a second module coupling link in a second position;

FIG. 25C is an enlarged fragmentary front phantom view of the generator system of FIG. 25 showing a third module coupling link in a third position;

FIG. 26 is a key diagram for the assembly of drawing FIGS. 29-33 into a composite schematic circuit diagram for components of the solar generator module of the second embodiment;

FIG. 27 is a top level block diagram of the main circuit components of the solar generator module of the second embodiment, as shown in FIG. 22;

FIG. 28 is a detailed circuit diagram of a battery bank and associated circuit breaker components from FIG. 27;

FIG. 29 is a detailed circuit diagram of the maximum power point tracker (MPPT) and battery charge controller components from FIG. 27;

FIG. 30 is detailed circuit diagram of the rectifier and associated connection relay components from FIG. 27;

FIG. 31 is a detailed circuit diagram of interconnections with a portion of the main control unit (MCU) from FIG. 27;

FIG. 32 is a detailed circuit diagram of interconnections with a further portion of the MCU and the DC/AV inverter from FIG. 27;

FIG. 33 is a detailed circuit diagram of an AC sensor and AC bus control relay associated with the AC bus of FIG. 27;

FIG. 34 is a front perspective view of a solar generator module 400 of a third embodiment of the invention;

FIG. 35 is an enlarged fragmentary view of the solar generator module 400 of FIG. 34 showing detail of a removal wheel member;

FIG. 36 is an enlarged fragmentary view of two adjacent solar generator modules of the system shown in FIG. 37, showing detail of the module interconnection arrangement; and

FIG. 37 is a top perspective view of a solar generator system utilising two connected modules of the kind shown in FIG. 34.

Note: Some of the images of the solar generator module included in this document include the words ‘SOLAR BLOX’ which is the proposed commercial branding for the solar generator modules of the invention and has been submitted for registration as a trade mark in a number of jurisdictions.

### DETAILED DESCRIPTION OF PREFERRED EMBODIMENTS

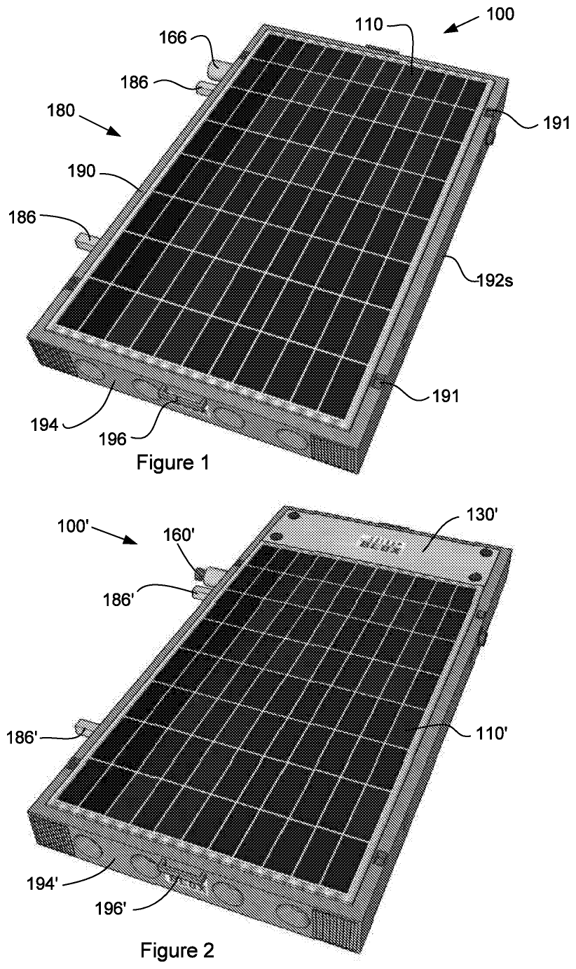

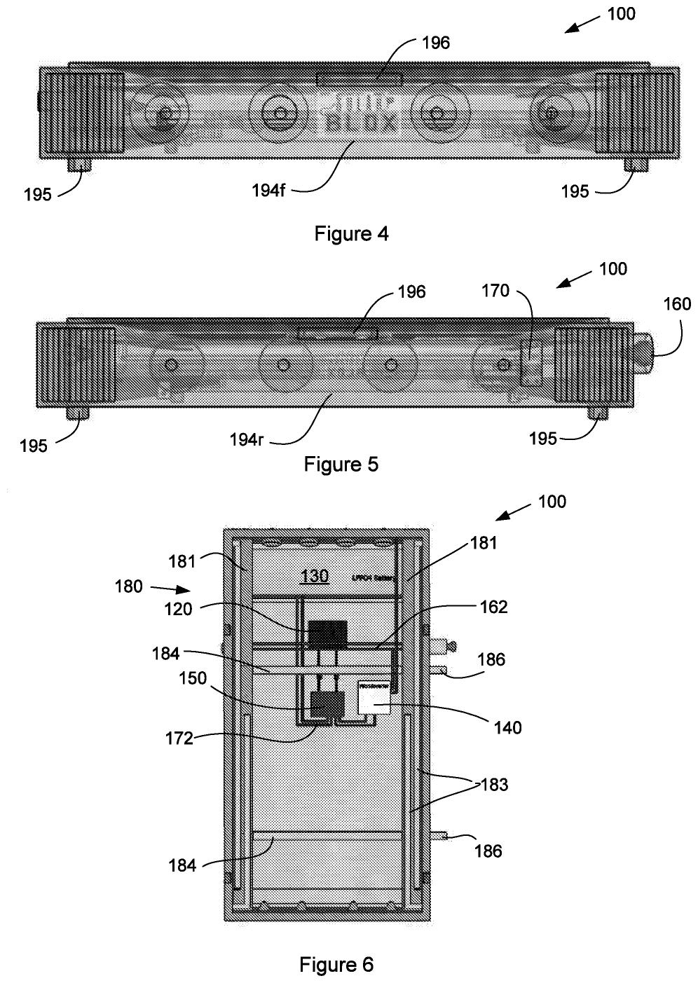

The solar generator module 100 of a first embodiment of the invention, as illustrated in FIGS. 1 and 4-6 includes an array of solar photovoltaic cells 110, here in the form of a single solar PV panel of 200 W output rating, although it will be appreciated that several smaller panels may be utilised in the array. The solar PV array 110 is arranged in a unitary package 180 and mounted to a rugged frame 184 (see FIG. 6) in order to shield the solar PV panel/s from transportation shocks. The package 180 includes an outer casing 190 that surrounds the solar PV panel 110 in the present embodiment, the casing including side faces 192 and end faces 194. A front end face 194f is shown in FIG. 4, whilst a rear end face 194r is shown in FIG. 5, the end faces including lifting handles 196 that are horizontally disposed. In the present embodiment, the rear end face 194r of the outer casing 190 includes a DC outlet 170, providing 5v USB and/or 12v supplies. If required, a battery charging port may also be included on an end face of the casing 190.

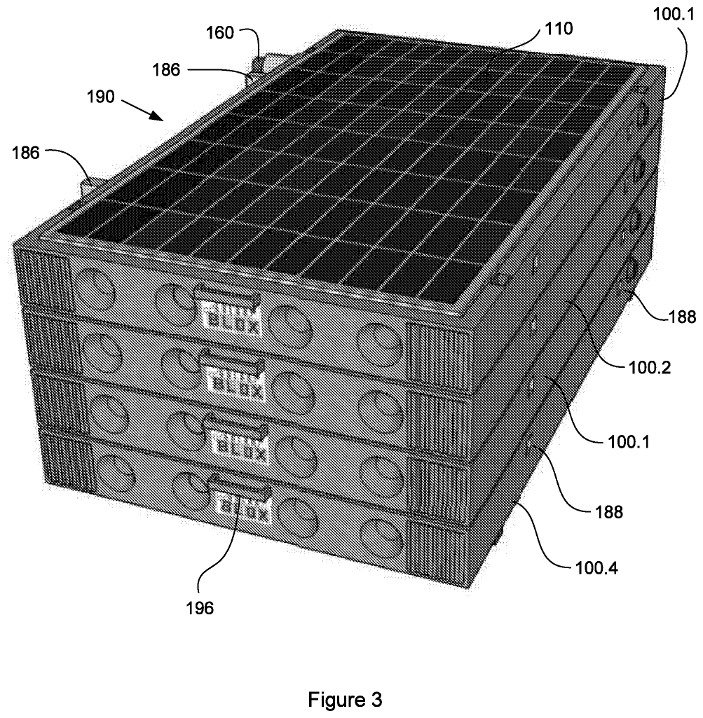

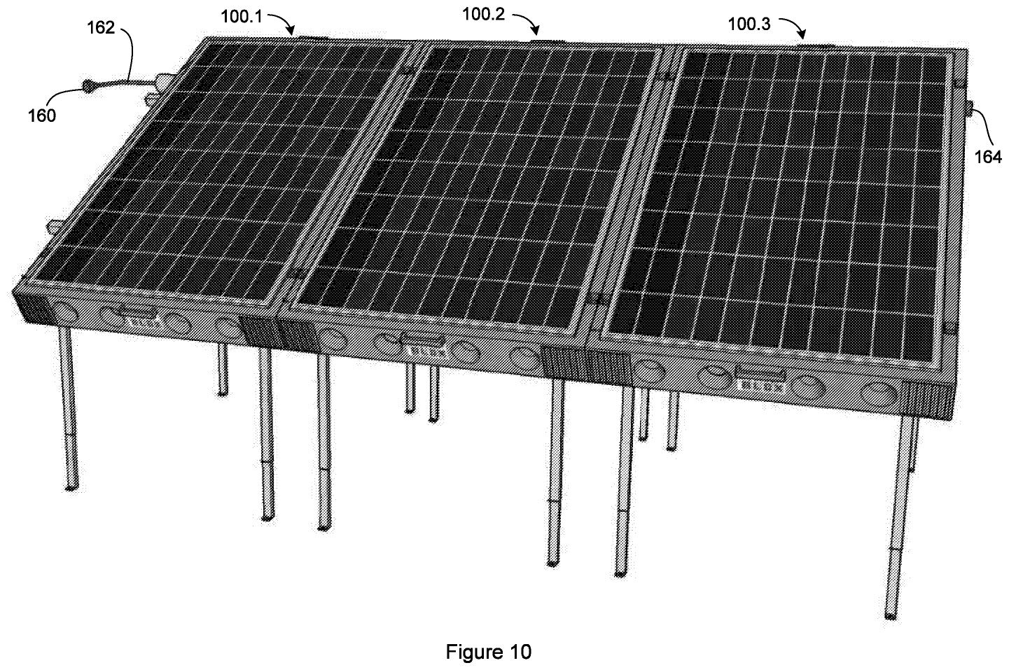

The side faces 192 of the outer casing 190 are provided with engagement formations, here including protrusions or spigots 186 extending from a left side face 192p and cooperating recesses or sockets 188 formed in a right side face 192s (see also FIG. 3). The engagement formations are for the purpose of mechanically coupling adjacent modules together (see FIG. 10), which formations will be further described in relation to FIGS. 6 and 8-10.

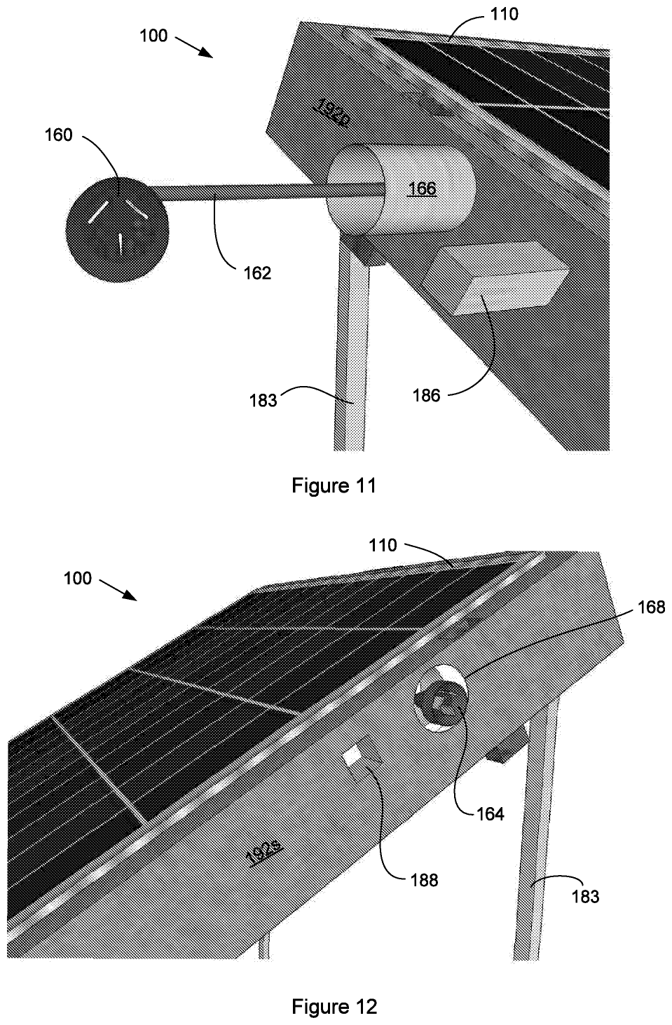

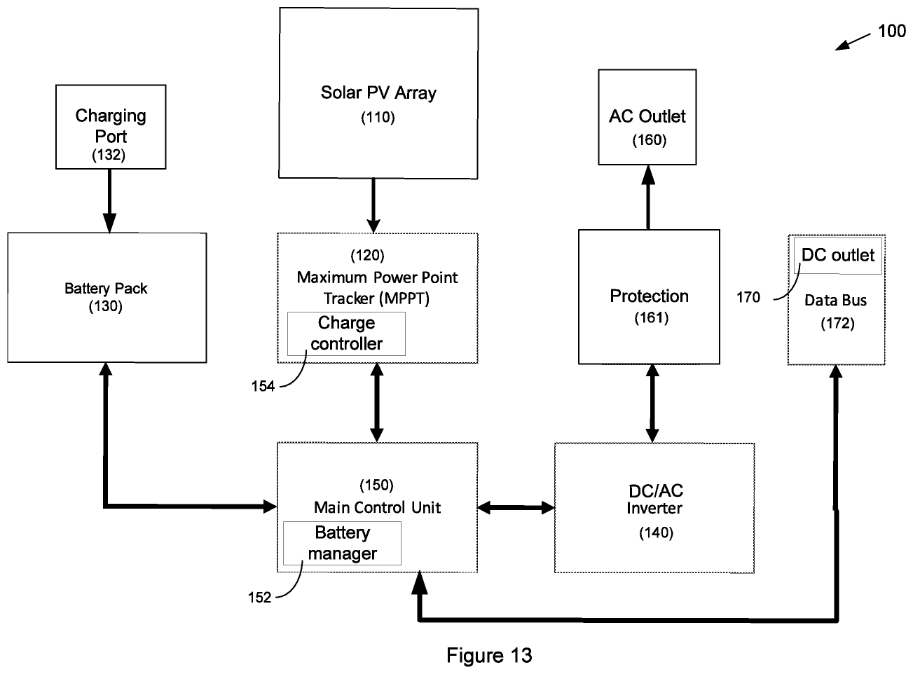

Also provided on the left side face 192p of the casing 190 of the present embodiment is an electrical connector, here in the form of an AC outlet receptacle 160 attached to a retractable cord 160, see also FIG. 11. On the right side face 192s there is provided a complementary electrical connector, here in the form of an electrical inlet plug 164, see FIG. 12. The inlet plug and associated cabling of the embodiment facilitates electrically linking of an AC bus (162, see FIG. 13) internal to the solar generator module 100 to an adjacent solar generator module (e.g. 100.2, see FIG. 10). Other configurations of electrical connectors, depending on the electrical voltage and/or current carried, may be employed in the alternative.

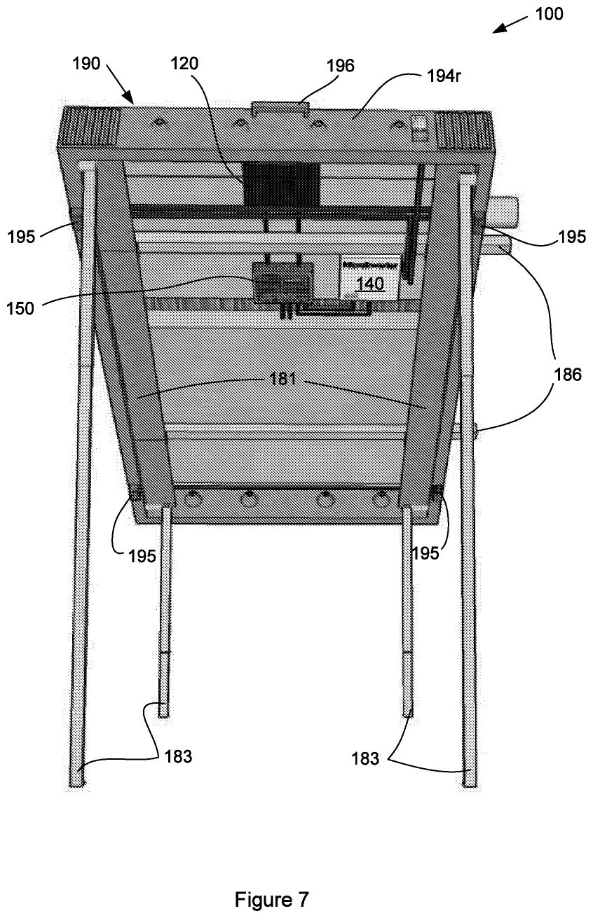

It will be appreciated from FIGS. 3 to 5 that the outer casing 190 is arranged to facilitate vertical stacking of the solar generator modules 100.1, 100.2, 100.3, as may be desirable for transport or storage. In the present embodiment, top peripheral faces of the casing 190 are provided with locating apertures 191 which are engageable with locating lugs 195 which depend from back peripheral faces of the casing, see also FIGS. 6 and 7, during stacking. The cooperating lugs and apertures minimise relative lateral movement of stacked modules 100 and space the modules apart to prevent direct loading of the solar PV array 110.

Turning to FIG. 6, which shows a back view of the solar generator module 100, some of the main electrical components that are mounted integrally under the solar PV array 110 and within the casing 190 can be seen. The components shown include a solar panel interface unit 120, storage battery 130, a DC/AC inverter 140 and main control unit (MCU) 140, together with wiring including an AC bus 162 and DC/data bus 172. The outer casing 190 is strengthened by the frame 184 having longitudinal plate sections 181 and lateral members spanning sides of the casing, which members are extensions of the outwardly protruding spigots 186 and include the sockets 188 at enlarged opposite lateral ends.

The storage battery 130 of the embodiment utilises lithium/iron/phosphate (LiFePO₄) cell technology and can have either a 480 Whr or 960 Whr rated storage capacity. The inverter is suitably a micro-inverter having either 500 w or 1 kW capacity, as required by selected battery capacity. Further details of the functions of these components are discussed below in relation to the component block diagram in FIG. 13.

In FIGS. 7 to 9 there is shown a solar generator module 100 having a mounting structure including a plurality of adjustable support legs 183, that are pivotally mounted to the frame 184 near each end of longitudinal plate members 181 where adjacent to the outer casing 190. The pivots 185 are suitably arranged with detents to lock in place in number of preselected angular positions relative to the casing. The support legs 183 of the embodiment are also adjustable in length, including a plurality of telescoping sections, each of tubular construction. A foot plate 183p is provided on a distal end of each leg to resist sinking on soft surfaces, and also include an eyelet thereby allowing bolts or pegs to secure the module 100 to the ground.

The adjustable support legs allow the solar array 110 to be conveniently angled to the position of the sun as it transits the sky, in order to maximise solar energy capture in any given season or global location. As shown in FIGS. 7 to 9, the solar array 110 of module 100 is disposed, by adjustment of support legs 183, at approximately 30° to the horizontal thereby capturing energy radiated by a typical winter sun in some locations.

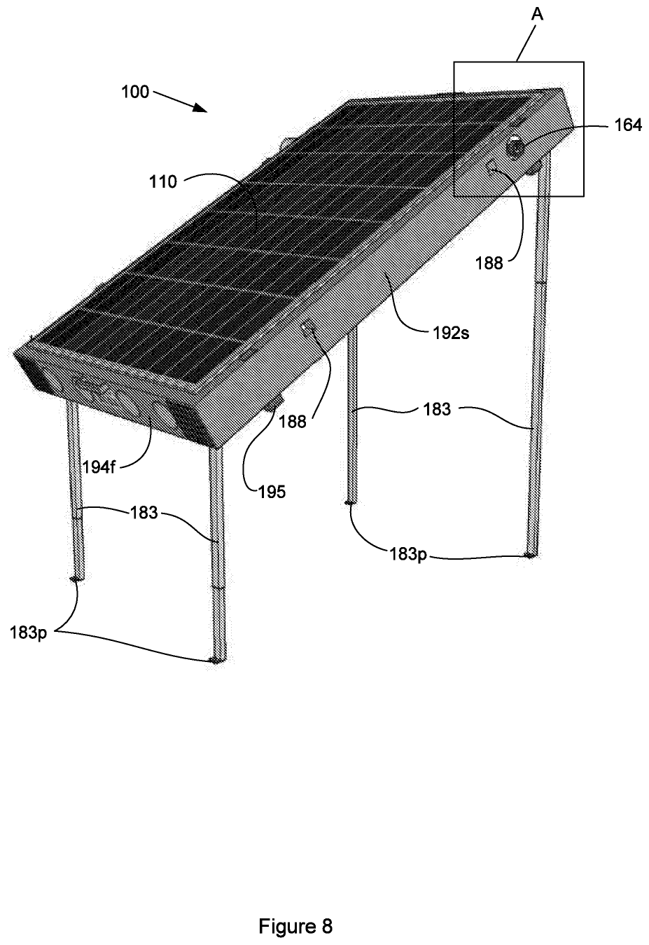

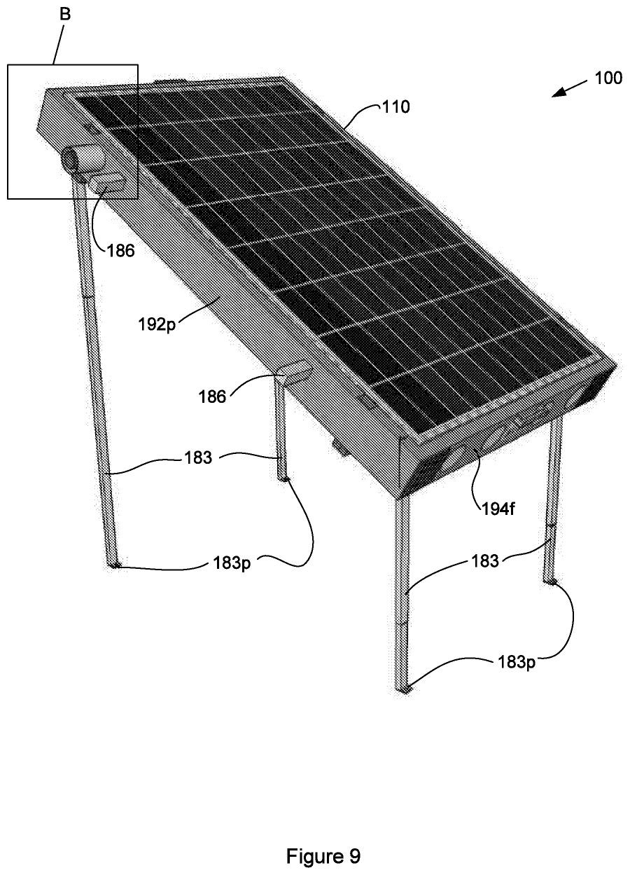

Turning to FIG. 10, there is shown a solar generator system comprising a number of solar generator modules 100 which are elevated on supporting legs 183 deployed from a folded position below (cf. FIG. 6), and have been connected together in side-by-side relation. For example, the spigots 186 protruding from the left side face 192p of the casing 190.2 of centre module 100.2 (cf FIG. 9) are mechanically attached to sockets 188 provided in the opposing right side face 192s of the casing 190.1 of outer module 100.1 (cf FIG. 8). The process is repeated for opposite end module 100.3, and it can be seen how the modules are connected together, suitably in a releasable click-fit arrangement, into a multiple-module system.

Prior to mechanical attachment of modules 100.1 and 100.2, the AC outlet receptacle 160 is withdrawn from centre module 100.2 (cf FIG. 11) and connected with the AC inlet plug 164 of outer module 100.1 (cf. FIG. 12) to electrically link the modules 100 to provide a common AC bus 162 therebetween. Note that, in the embodiment of the solar generator module 100 as illustrated in FIGS. 11 and 12, a protective tubular sleeve 166 on left side face 192p, which is received within an opposing hole 188 on right side face 192p, is provided to resist inadvertent electrical disconnection of AC inlet plug 164 and outlet receptacle 160.

The solar generator module of the first embodiment comes in two variants: a back plate integrated battery variant 100 as depicted in FIG. 1 and a top mounted battery variant 100′ as shown in FIG. 2 (wherein similarly referenced features are marked with a prime), which varies only in relation to placement of the battery. The two variants may be used to accommodate different environmental conditions, for example the module variant 100′ with a top mounted battery 103′ is considered to offer better heat rejection.

A block diagram of the main electrical components of the solar generator module 100 of the first embodiment is shown in FIG. 13. The components include a solar panel interface unit 120, which here includes a maximum power point tracker (MPPT) that receives the raw DC supply generated by the solar PV array 110. The interface unit of the embodiment further includes a charge controller 154 which is coupled to a battery pack 130 including one or more storage batteries for storing solar energy supplied by the panel/s comprising the solar array 110.

A main control unit (MCU) 150 for controlling DC power flows within the module 100 including from either the solar panel interface 120 or the battery pack 130 to an DC/AC inverter 140. The MCU also incorporates a battery management sub-system 152 for controlling power drawn from the battery pack 130, as required from time to time to augment that supplied directly from the solar PV array 110. A charging port 132 may also be provided for direct charging of the battery pack 130.

The AC output of the inverter 140 is switchable between a nominal 115v and 230v AC voltage levels and provided via a protection sub-system 161 and AC bus 162 to an AC power outlet. The protection sub-system 161 provides both short-circuit and over current protection for the internal inverter 140 and connected external loads and/or additional solar generator modules linked in the manner described in relation to FIG. 10, above. On the DC side of the module 100, there is also provided a data bus 172 emanating from the MCU 150 and an associated DC outlet 170, for example a 5v USB type connector.

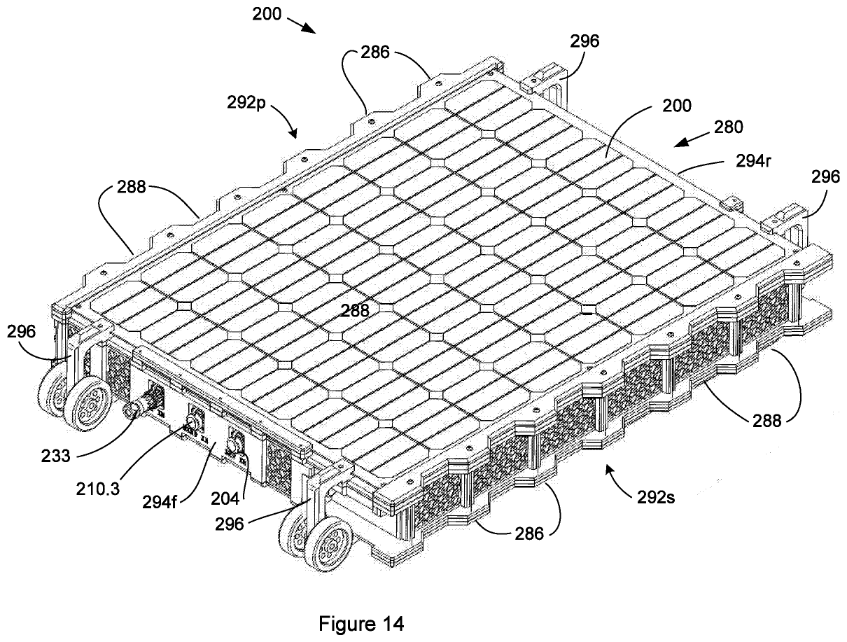

A second embodiment of the solar generator module 200 of the invention which has been further developed by the Applicant is now described, at least initially, in relation to FIGS. 14 to 20 which illustrate external features of the module. Like the first embodiment, the present module 200 includes a substantially planar solar photovoltaic (PV) panel 201. The solar panel is rated at 160-W, although it will be appreciated that other PV panel ratings may be employed, such as a smaller module with an 80-watt panel or a larger version with a 300-watt panel. It may also be possible in future to move to higher efficiency PV panel, e.g. 170 watts, but having the same size as the current 160 W rated panel. The present PV panel 201 is surrounded by a perimeter casing 290 composed of vacuum formed or injection moulded plastics material and forms a unitary package 280.

However, the casing 290 of the second embodiment is characterised by side faces 292 having complementary engagement formations that include alternating protrusions 286 and recesses 288 in the form of a saw-tooth or castellated structure, which formations happen to be of angular truncated configuration in the illustrated embodiment. As best appreciated from FIG. 16, the castellated engagement formation on the left side face 292p of the casing 290 meshes with the castellated engagement formation on the right side face 292s.

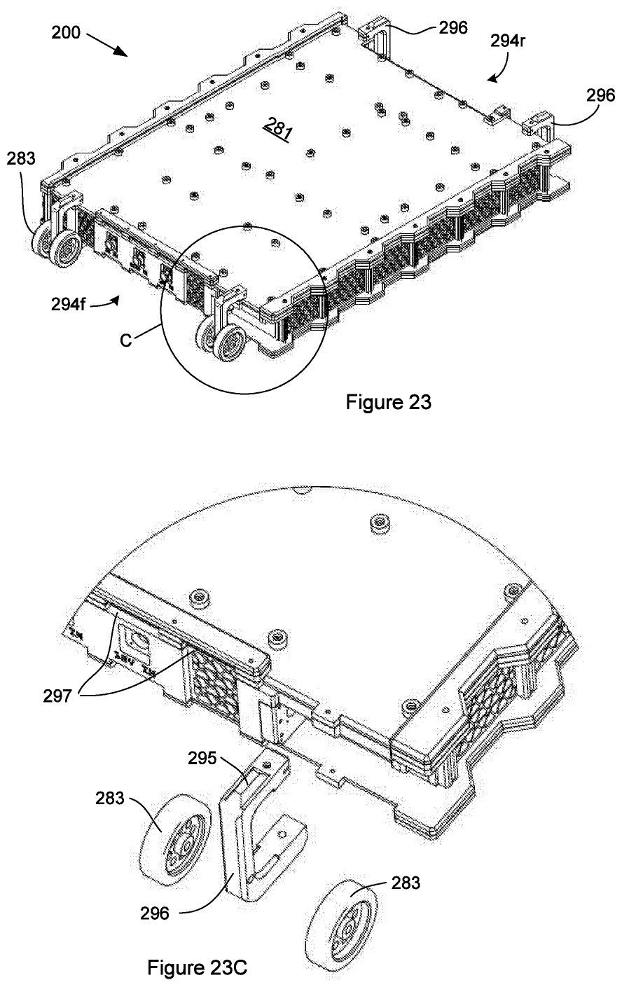

End faces 294 of the casing are again provided with lifting handles 296 on both a front end face 294f and a rear end face 294r. In this embodiment, there are a pair of spaced lifting handles 296 which are seen upright on each end face of the casing 290. The handle pair on the front end face 294f also include respective wheels 283, which are further described in relation to FIGS. 23 and 23C, below.

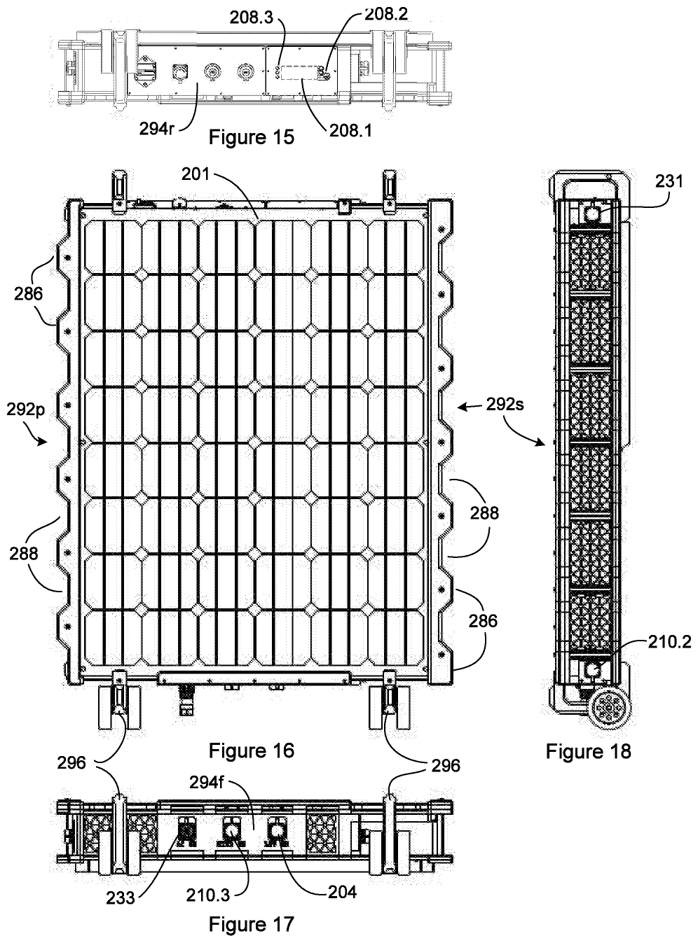

The rear end face of casing 290, best seen in FIG. 15, further includes outlet connects for a 12v/24v DC supply 220, a 12v/5v DC outlet, together with a user switch pad 208.3, indictor LEDs 208.2, a user interface display screen 208.1 collected in a membrane panel 208. The front end face 294f further includes inlet connectors for an external AC connection 233, a data bus connection 210.3 for external programming, and an external 12v AC charging port 204; see FIG. 17.

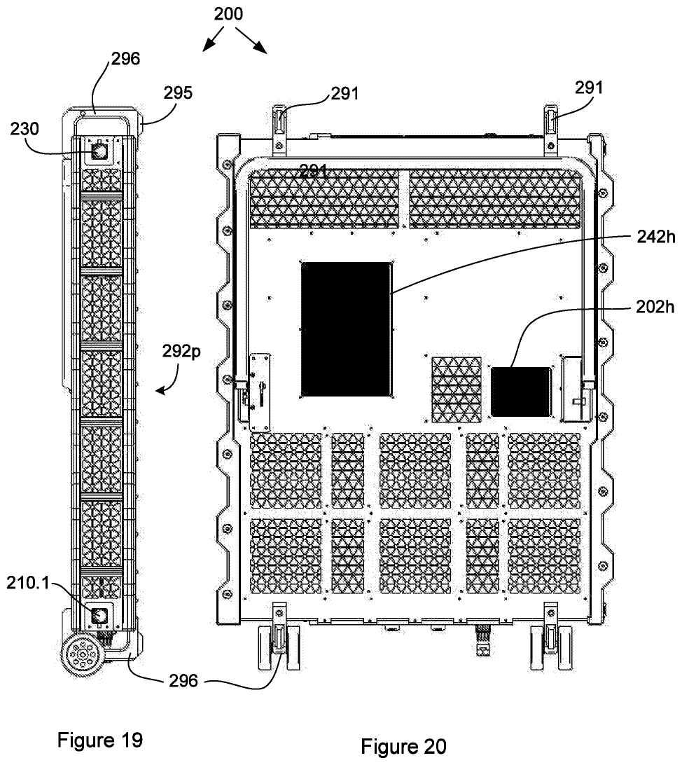

Turning to the right side face 292s of the casing 290, there is included a right AC connection 231 and a right data connection 210.2, as shown in FIG. 18. These connections are mirrored on the left side face 292p of the casing as shown in FIG. 19, namely including a left AC connection 230 and a left data connection 210.1 for linking a number of modules together in a chain. FIG. 20 is a back view of the module 200, illustrating heat sinks for each of inverter 224h and solar panel interface unit 202h.

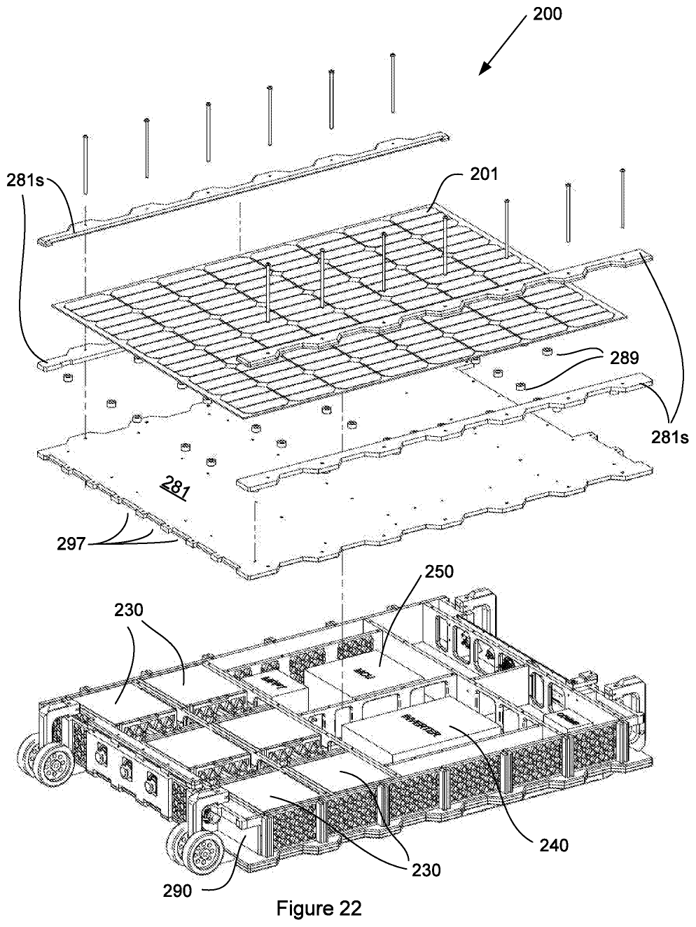

FIG. 23 shows a perspective of the module 200 without the solar panel 201 installed. There is shown a mounting plate 281 for the solar panel which carries a series of small resilient supports that elevate the panel slightly from the plate when installed. This elevation creates an air gap between the back face of the solar panel 201 and top of the plastic casing 290. This arrangement is desirable because the back of a solar panel can get very hot and the spacing assists in reducing the transmission of that heat through into the battery and electronics compartment below (see FIG. 22).

Additionally, air vents may be provided in the form of slots 297 in end faces 294 adjacent the top and bottom of the unit. These slots are designed to allow air to flow underneath the panel for the purposes of natural cooling of the back of the solar panel 201. This is because solar PV panels are more efficient when cooler, so allowing the back of the panels to cool increases their efficiency. Through natural convection as the back of the panels heat up and heat the air around them, that air will move out through the vents at the top and bottom towards cooler air.

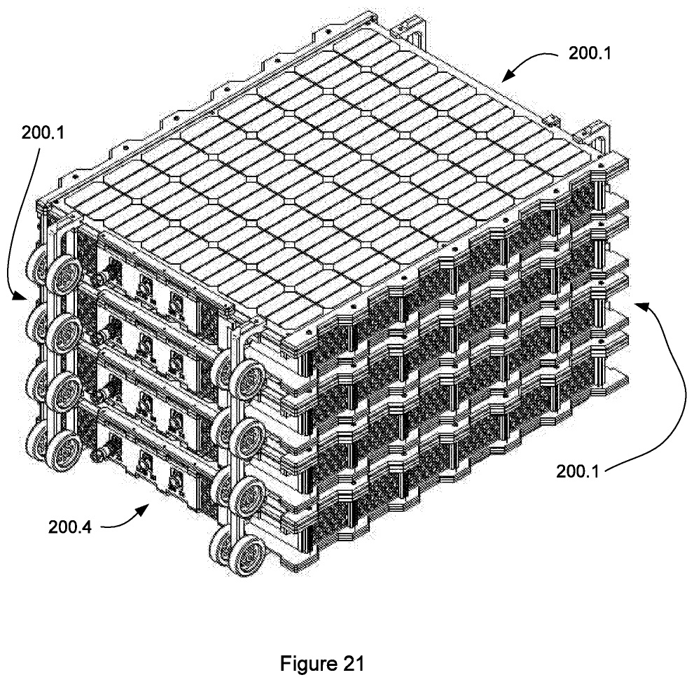

It can be seen in FIG. 21 that the modules 200.1, 200.2, 200.3, 200.4 are designed to be stacked on top of each other in a way that ensures the solar panels 201 are separated, and so there is not pressure directly on the panels. The stacking is facilitated by lugs 295 located on upper surface of the handles 296 that locate in cooperating apertures 291 provided in lower surface of the handles (see bottom view in FIG. 20).

FIG. 22 shows a partially exploded view of the casing 190 of the module 200, wherein both the solar PV panel 201 and supporting mounting plate 281 carrying an array of resilient supports 289 for the panel have been separated from an underlying chassis 287. The chassis 287 comprises a part of the rugged frame of the second embodiment, includes a number of component bays, including bays for storage batteries 230, an inverter 240 and main control unit (MCU) 250 that are together surrounded by the outer casing 290. Strip sections 281s of the casing 290 include the castellated engagement formations discussed above are employed to locate the solar PV panel 201 and mounting plate 281 in place, being secured by arrays of bolts or pins. In the embodiment, side edges of the mounting plate 281 are also castellated.

FIG. 23 shows the module 200 assembled, but without the solar PV array, whilst the exploded view in FIG. 23C illustrates detail of handles 296, including upstanding lug 295, and a mounting structure including optional wheel members 283 that are conveniently attachable to the handle. The wheel arrangement allows modules to be conveniently re-positioned, for example by a person grasping the handles at the rear end of the casing 190.

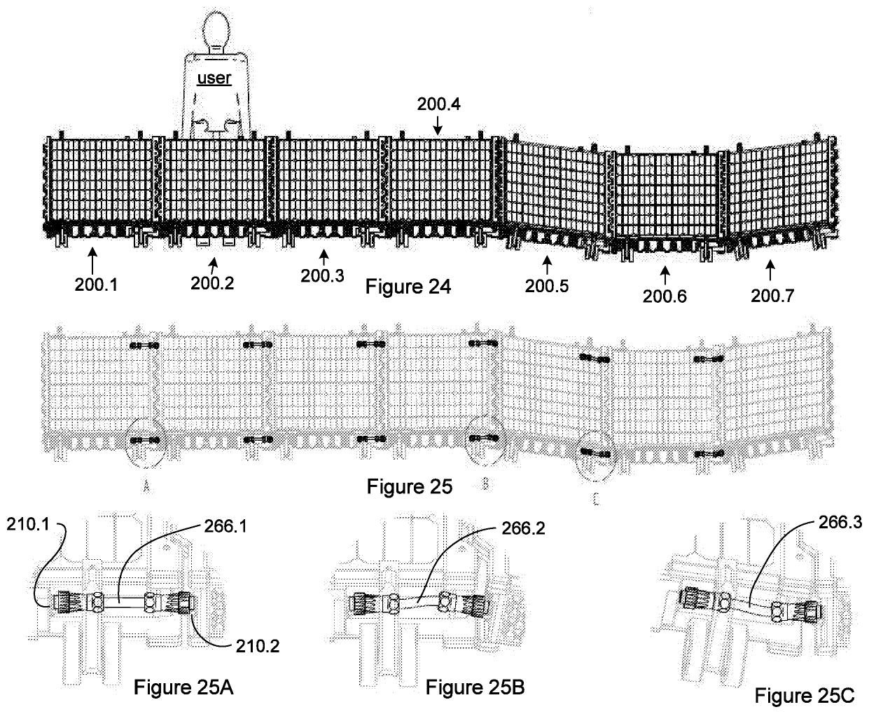

FIGS. 24 and 25 to 25C show how multiple solar generator modules 200 can be connected together. The sawtooth type or castellated formations on the opposed side walls allows adjacent modules to slide comfortably next to each other. The modules are then held in place by connectors 266 spanning side connections, for AC bus 230, 231 and data bus 210.1, 210.2 respectively on each side of the module. This coupling connections into the left side of one unit and right side of another, as apparent in FIG. 25.

Detail of the connectors 266 can be seen in FIGS. 25A, 25B and 25C that aim to illustrate the available range of relative movement between modules 200. The connectors 266 include a hardened but resilient outer protective sleeve fixed to knurled terminations and enclosing wiring suitable for either the AC voltage or data bus, as required. When attached, the connectors 266 can handle a certain amount of load before safely failing, by (for example) the over-loaded connector safely releasing from its cooperating socket. The flexibility provided by the connectors allows a solar generator system having a number of interconnected modules to handle a certain amount of terrain movement between the modules as demonstrated in FIG. 25. Additionally, it means that longer cables can be ordered to deal with wider separation of units if required.

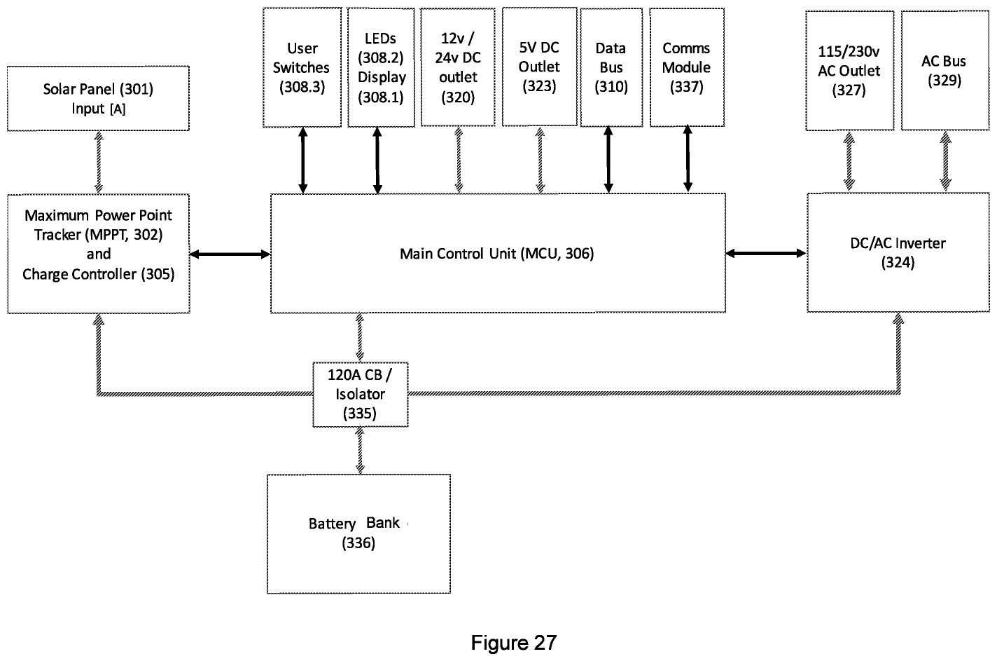

In FIG. 27 there is shown a high level block diagram of the main functional components of solar generator power management and control circuitry 300 for use in the module 200 of the second embodiment. The function components include a solar panel interface unit including a maximum power point tracker (MPPT) 302 and battery charge controller 305, which receives electrical energy at DC voltage from a solar PV array via solar panel input 301. The panel interface unit is coupled to a battery bank 336 by a circuit breaker isolator 335, which is in turn coupled to an DC/AC inverter 324. The inverter 324 has an AC output coupled to a switchable AC outlet receptacle 327, and is also coupled to an AC bus 329.

Each of the MPPT 302, charge controller 305, circuit breaker 335 and DC/AC inverter 324 operates under the control of a main control unit (MCU) 306. The MCU 306 also provides a number of control or DC voltage outputs as follows: a) a user interface function including switches 308.3, status LEDs 308.2 and a display 308.1, a switchable 12v or 24v DC outlet 320, a 5v DC outlet 323, a data bus link 310 and a communications module 337.

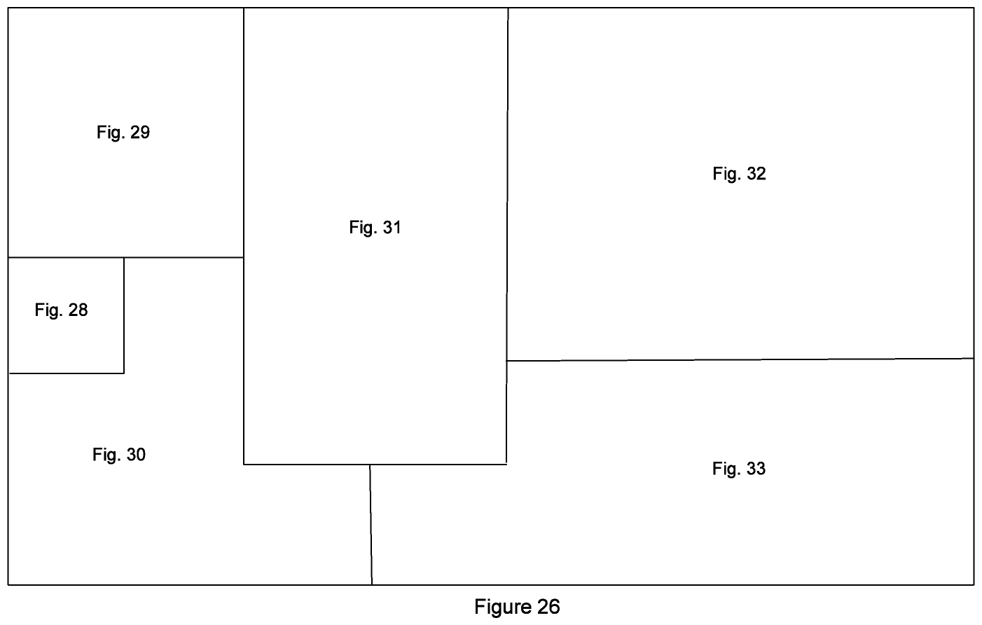

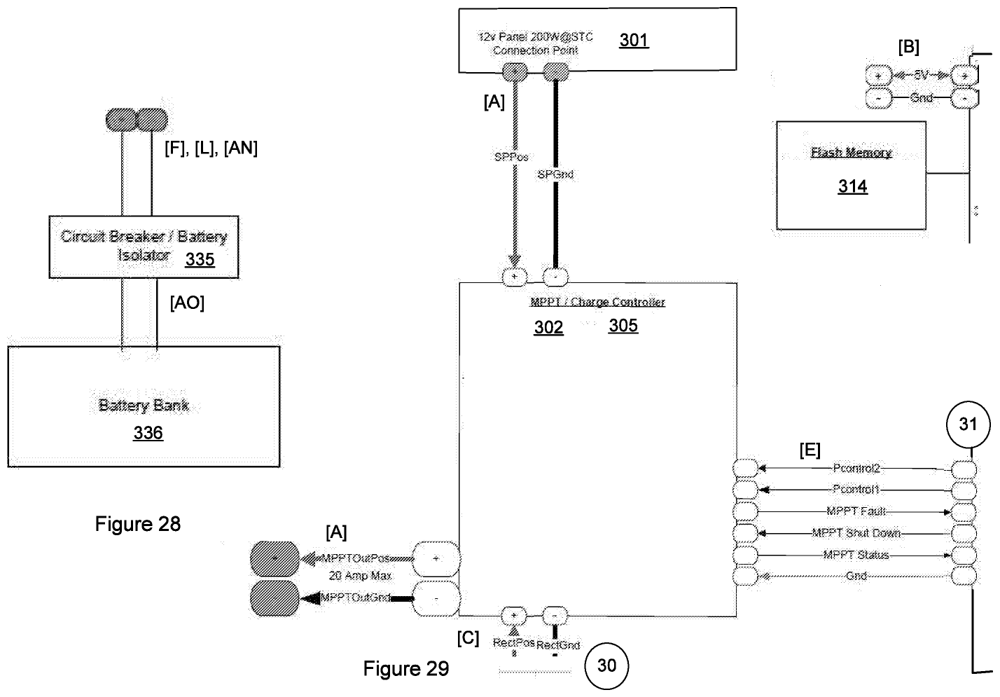

Turning to FIG. 26, this is a key diagram for assembly of a group of subsequent drawing figures—namely FIGS. 28 to 33 illustrating the power management and control circuitry 300 at a greater level of detail, including the controls required for linked solar generator modules. It should be noted that the encircled reference numerals direct the reader to the appropriate drawing figure number wherein the circuitry logically continues. Interconnecting circuitry within each drawing is identified by alphabetical symbols placed between square brackets, for example [A] identifies the link between the solar PV panel array 201 and solar panel interface unit, including MPPT 302 shown in FIG. 29.

FIG. 28 shows circuitry for the battery bank 336, which may comprise a number of battery packs (for example as illustrated in FIG. 23), and the interconnected circuit breaker/battery isolating switch 335. The circuit breaker effectively forms an electrical node between each circuit connection from the charge controller [F], MCU [L] and Inverter [AN] to the battery bank [AO]. The circuit breaker 335 is manually resettable by the user when tripped and can be manually opened to isolate the supply from the battery, as desired.

FIG. 29 shows a connection point for the solar PV panel and the circuit [A] to the MPPT 302. The MPPT functions using a conventional method of using buck/boost converters to operate the solar panel at voltage that optimises the current output from the panel thereby extracting the maximum power point. This maximum power point changes dynamically with incident solar radiation and related environmental conditions, such as ambient temperature. The MPPT is configurable to handle a variety solar panels allowing the unit to be used with smaller panels, larger panels or a series of panels as necessary.

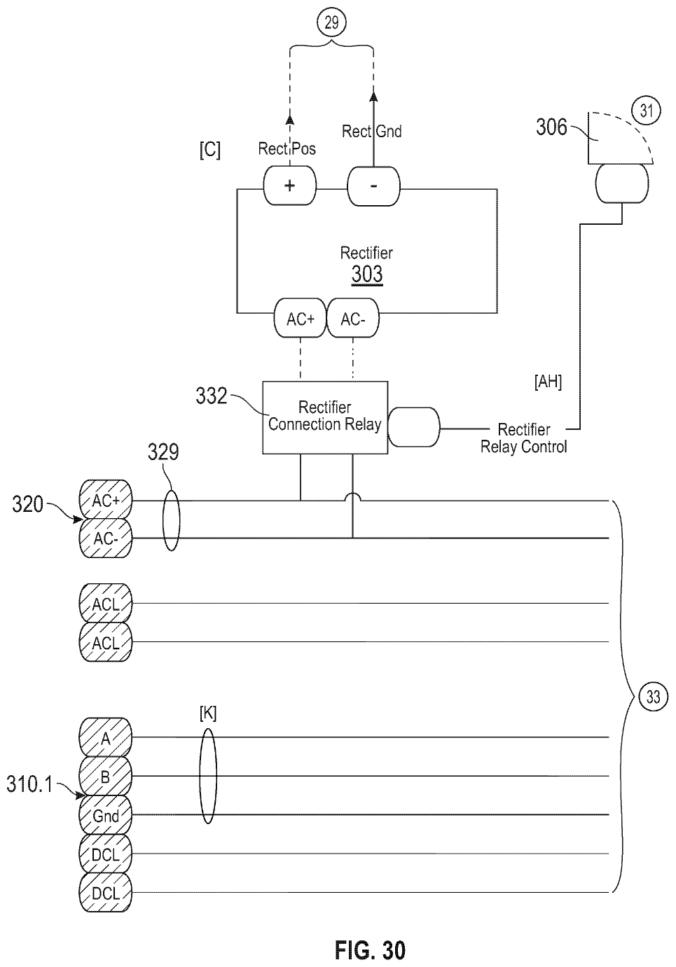

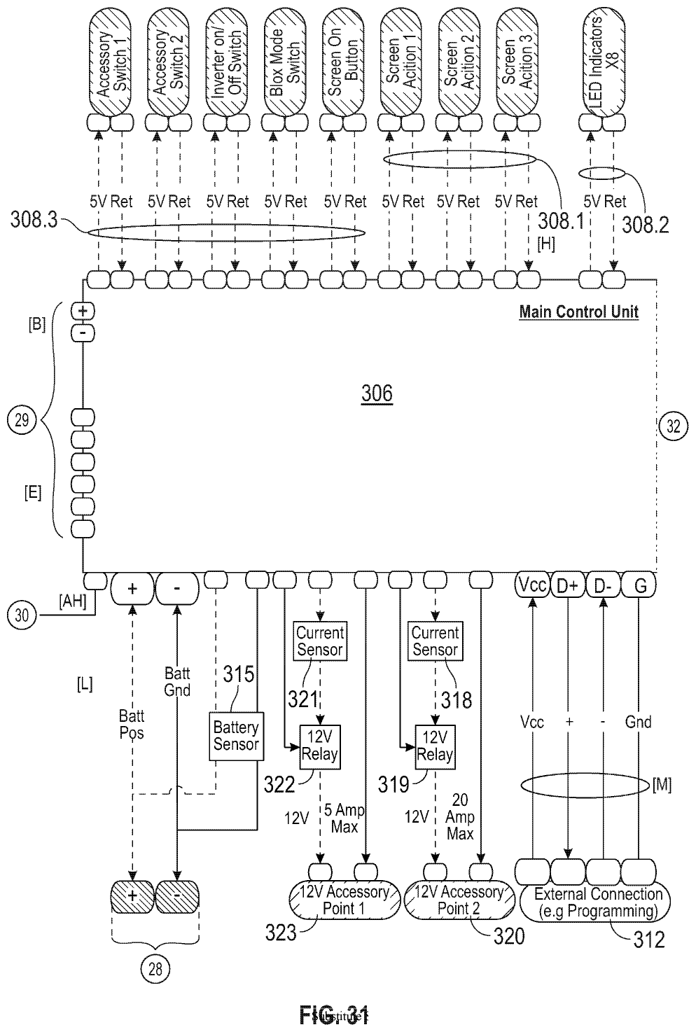

The MPPT and charge controller (CC) 305 are, in the present embodiment, part of the same integrated circuit controller device. Accordingly, the charge controller can react to control information provided from the MCU via lines [E] as well as the DC output of the MPPT which is at a level optimised for the solar panel that is also provided to the charge controller. The charge controller is further connected via lines [C] to a rectifier (see FIG. 30) for charging the battery bank from an external AC source, including any interconnected solar generator modules.

Also shown in FIG. 29 is a non-volatile or flash memory device 314, which stores information in a form that is not adversely affected by power loss. The flash memory is connected to the MCU 306 (see FIG. 31) and stores information of the kind including module serial number, manufacturing data, battery conditions, performance and configuration information for a particular module. The adjacent connection [B] also allows for connection of a 5v back-up battery direct to the MCU.

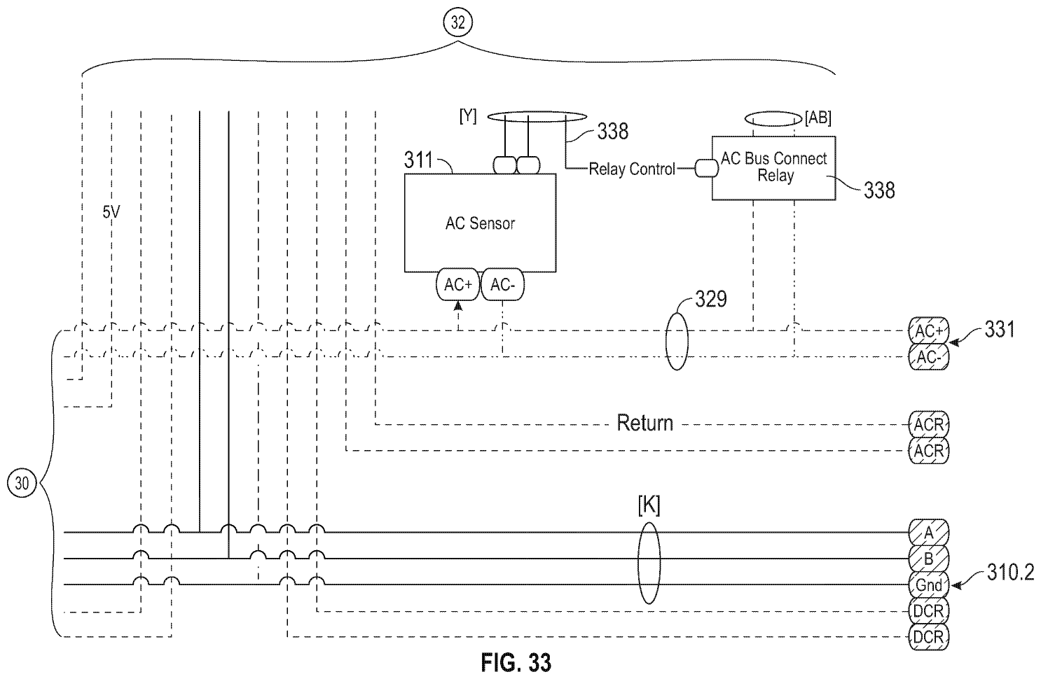

FIG. 30 illustrates rectifier 303 which converts AC power from AC bus 329 into 12v DC power and supplies same to charge controller 305, as mentioned above in relation to FIG. 29. A rectifier connection relay 332, which is controlled by line [AH] from MCU 306 (see FIG. 31), is interposed between the AC bus 329 and the rectifier 303. The rectifier has a typical capacity of 60 W and is capable of handling AC supplies of either 115v 60 Hz or 230v 50 Hz, as required. Also shown are sensing lines ACL relating to connection of an external AC bus, which will be discussed later in relation to FIG. 33. The lower portion of FIG. 30 also shows DC bus K and associated external sensing lines DCL, which are similarly described later in relation to FIG. 33.

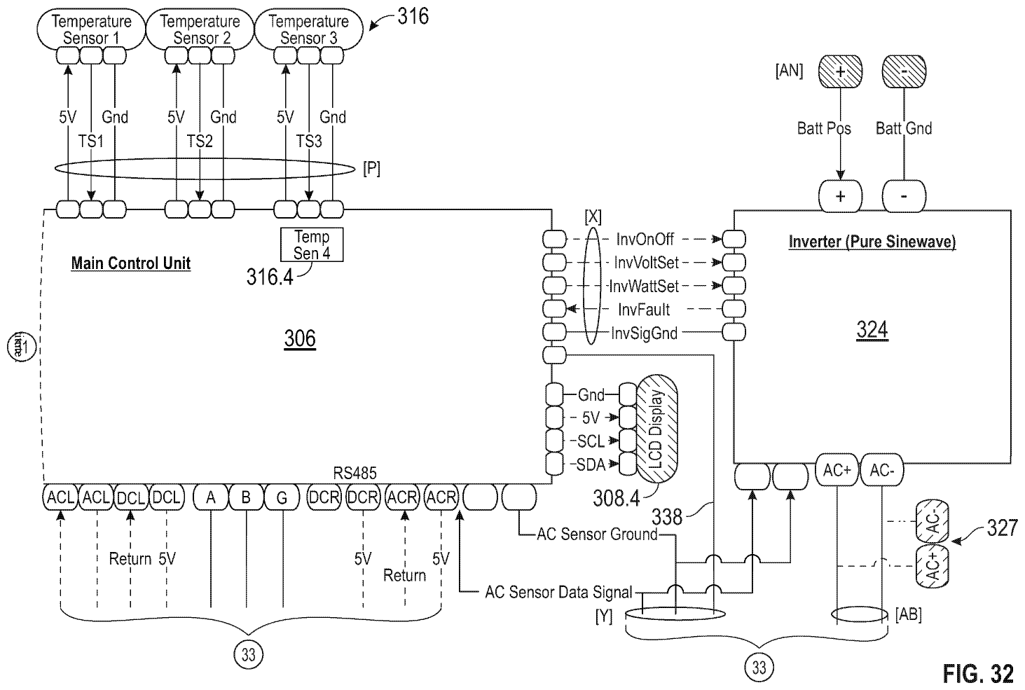

A portion of the main control unit 306 for the solar generator module 200 is depicted in FIG. 31 (see balance in FIG. 32). The MCU takes inputs from a number of sensors and interfaces and uses these inputs for decision making, resulting in outputs that include switching control (for example via relays, e.g. rectifier control relay via line AH), driving user displays and indicators, and issuing control commands to other circuits (e.g. MPPT/CC and inverter components). The MCU also controls communication with other modules/other devices via the data bus 310 (see FIG. 32). The MCU is centred on a large microcontroller, such as an ARM 1675 device which is what the module control software is loaded onto and where all the programmed decisions are executed.

The connections B and E have been described above in relation to FIG. 29, and similarly connection [AH] in FIG. 30. Additional detail of the battery pack interface [L] that provides DC power (positive and ground) from the battery bank 336 to the MCU 306. The MCU functions to convert the power provided by the battery bank to a power level that allows for the operation of the module's integrated circuits 300. Additionally, the MCU 306 switches, via relays, power from the battery bank to its DC accessory outlet points 320, 323. FIG. 31 also shows a battery sensor 315 which measures available battery voltage and other battery parameters, such as charge state, to inform the MCU accordingly.

Current sensors 318, 321 monitor the current delivered by the DC outlet lines to accessory points 320, 323 and each report this information back to the MCU 306. The MCU uses this information for a couple of purposes. One purpose is tracking the output of power, i.e. how much power is being supplied by the outlet. A second purpose is to watch for over current conditions, that is if the user tries to draw to much current or short circuits an outlet then the MCU will detect this abnormal state and turn off the associated relay 319, 322 (this is both a protection and safety feature). Also the current sensors allow the MCU to make decisions regarding power saving. If the MCU detects that the outlet has been active for some specified period of time but is not presently being used, then it may turn off the respective outlet. This is because the outlet can consume power in the relay “on” position.

There are connection points 312 also provided to the MCU 306 that allow for external programming, including connection lines M, that can presently operate in either of two protocols used for programming and debugging purposes, namely JTAG and UART.

Turning to user interface connections 308 to the MCU 306 on the upper part of FIG. 31, there are included screen action or cursor control group 308.1; LED indicator drivers 308.2; and accessory switches, inverter on/off switch, a module mode switch, and a display screen on button in switch group 308.3, which are together grouped on user interface bus H. In one preferred arrangement for the second embodiment of the solar generator module, these grouped up set of interfaces go separately to each user button, the user display screen and to indicator LEDs that are part of a membrane switch/display panel 208 (as mentioned above in relation to FIG. 15).

Turning now to FIG. 32, there is shown the remaining connections to the MCU 306, including an array of temperature sensors 316. There are four (4) temperature sensors in the present embodiment. Two sensors 316.1, 316.2 are wired to the battery compartment, one 316.4 that is onboard in the electronics compartment and one 316.3 that is available to measure the external ambient temperature. This temperature information is used to tell the MCU 306 if it needs to shut down certain electronic equipment or batteries and allow a cool down. The temperature sensor bus P includes, for each sensor, provision of Vcc and ground lines to the temperature sensors, the temperature sensors return via a single wire a signal that is interpreted to provide a temperature reading.

The further component illustrated in FIG. 32 is the inverter 324, preferably of the pure sine wave type and rated at 1 kW in the embodiment. The MCU 306 sends to the inverter, via inverter bus X, signals to provide instructions for on/off, voltage setting, wattage setting and sensor data. The inverter provides a return signal that can indicate a fault, and there is a signal ground line. DC power is supplied to the inverter 324 from the battery pack (see FIG. 28) by input lines AN. Following inversion by inverter 324, AC power at selected voltage (and frequency) is provided to AC bus [AB] and adjacent AC outlet 327.

A further control line (below inverter bus X) manages an AC bus connect relay 328, which is further described below, with the AC sensing signals in bus Y, in relation to FIG. 33. The MCU 306 may also provide interface lines for an external LCD screen 308.4, for example usable for an expanded MCU diagnostics display and/or in relation to external programming via interface M (see FIG. 31).

The connection lines on the lower edge of the MCU block will be further described in relation to FIG. 33 below. However, it is helpful to introduce the AC bus left sensor lines, which comprises lines ACL (×2), digital/DC bus left sensor lines DCL (×2), digital data bus A, B and G(nd)—according to RS 485, digital/DC bus right sensor lines DCR (×2), and AC bus right sensor lines ACR (×2). The left/right paradigm is helpful in understanding the routing of the “left” lines back to FIG. 30 (when viewing FIG. 33), and the right lines in FIG. 33, which reflect the notional physical locations of respective connectors on respective side faces 292 of the solar generator module casing 209.

Turning to FIG. 33, there is shown an AC sensor 311 which determines whether there is any voltage on AC bus 329, including measurements of zero-crossings of the voltage sine wave. This information is fed back to the MCU 306 and inverter 314 via sensor/control lines Y, and an AC bus connect relay 328 selectively operated by the MCU via a relay control line 338 and connects the inverter 324 as required. It is across these interface lines Y that the inverter can sense if there is an existing AC signal on the AC bus 329 and decide to either synchronise to an existing voltage waveform or generate its own AC voltage.

The AC connection point 331, including active AC+ and neutral AC− conductors represents an end point of the AC bus within the module 200 which is terminated in the present embodiment by a connector 231 of the right side face (see FIG. 18). The forward and return sensing lines ACR allow the MCU 306 to sense when an external AC connection is made with the right side AC connector 231. There is a corresponding connection point 330 shown in FIG. 30 on an opposite end point of the AC bus 329, corresponding to connector 230 (see FIG. 19). Similarly, the forward and return sensing lines ACL allow the MCU to sense when an external AC connection is made with the left side connector 230. These sensing lines play a role in the linking of a number of solar generator modules into a system, such as illustrated in FIG. 24.

The RS 485 data bus K (lines A, B, Gnd) includes a similar arrangement for connection detection at each of the left data bus end 310.1 at module left side connector 210.1 using sensing lines DCL (see FIG. 30), and at the right data bus end 310.2 at corresponding module right side connector 210.2 connector using sensing lines DCR.

We turn now to discussing operations of the MCU 306 when two (or more) solar generator panels are linked together in a system, as per FIG. 24. The MCU constantly monitors charge in each battery bank 336. If for example 4 modules 200 are connected and AC power is required, after detecting battery state in each module, power will be drawn from the module with the most battery charge first, down to a certain, predetermined level then move to the module with the next highest charge state in order to maximise life of batteries and balance batteries. When the modules are exposed to sunlight and therefore charging, if one module is fully charged while another is a long way from full charge then the linked AC bus will be used to transfer charge from the fully charged module to the lower charge module, but only to the extent that the fully charged module stays at full charge (i.e. is being charged back as power taken out). This charging strategy allows for battery charge and discharge synchronisation without wasting power.

Young Battery Detection: If there are for example 3 modules in an established system, and then a 4th module added a couple of years later, the MCU will detect the younger battery pack and always seek to use it first so as to extend the life of older batteries (that is push the younger battery harder first).

Thermal Management: The MCU is constantly monitoring the temperature of batteries and internal power electronics and uses this information to determine which module to turn on/off. When operating in a chained system of modules, load will be cycled between modules in such a way as to optimise thermal conditions under the environmental constraints. Each MCU also has safety mechanisms to prevent components getting too hot and will disable sections and batteries in relevant modules, where necessary.

The MCU monitors load conditions and turns on/off inverters within the module chain to support load conditions. As part of battery synchronisation there are also built in rectifiers that allow individual modules to charge themselves from supply available on the AC bus. This is all done in controlled way based on economising on available sources of supply. For example, it is undesirable to be producing AC power through an inverter and simultaneously rectifying back to DC in order to charge batteries, as you just end up in an energy loss loop.

Referring to FIG. 27, it is intended that the communications module 337 be arranged to provide for optional GPS tracking of modules and a 4G wireless communications card to be built into modules, as required. For example, when modules are deployed by governments for disaster relief they can track location of units to recover later.

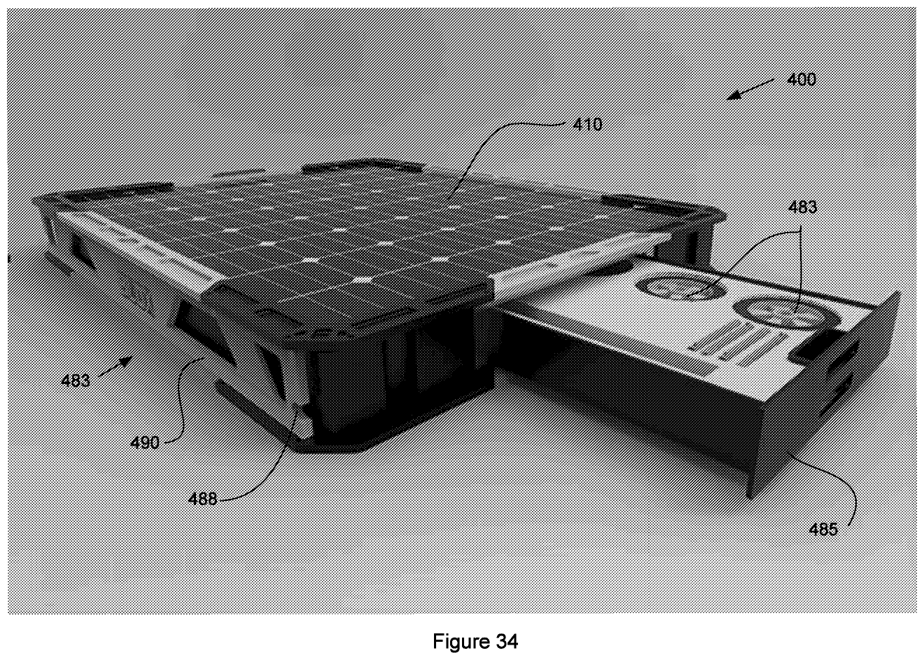

There is shown in FIGS. 34 to 37 a third embodiment of a solar energy generator module 400 of the present invention. The module is provided in a unitary package 480 having a rugged frame with an outer casing 490 surrounding a perimeter of a solar PV panel 410. Side faces 492 of the casing are each provided with recesses 488 for receiving protrusions 486 (see detail in FIG. 36) in order to attach adjacent modules 400.1, 400.2.

An end face of the outer casing 490 is provided with a compartment for removably receiving ancillary equipment for the module, such as mounting wheels 483. The compartment in the illustrated embodiment of the module 400 includes a slidable drawer section 485 with a pre-shaped retaining tray, but may simply include a hinged cover over the compartment in other variants.

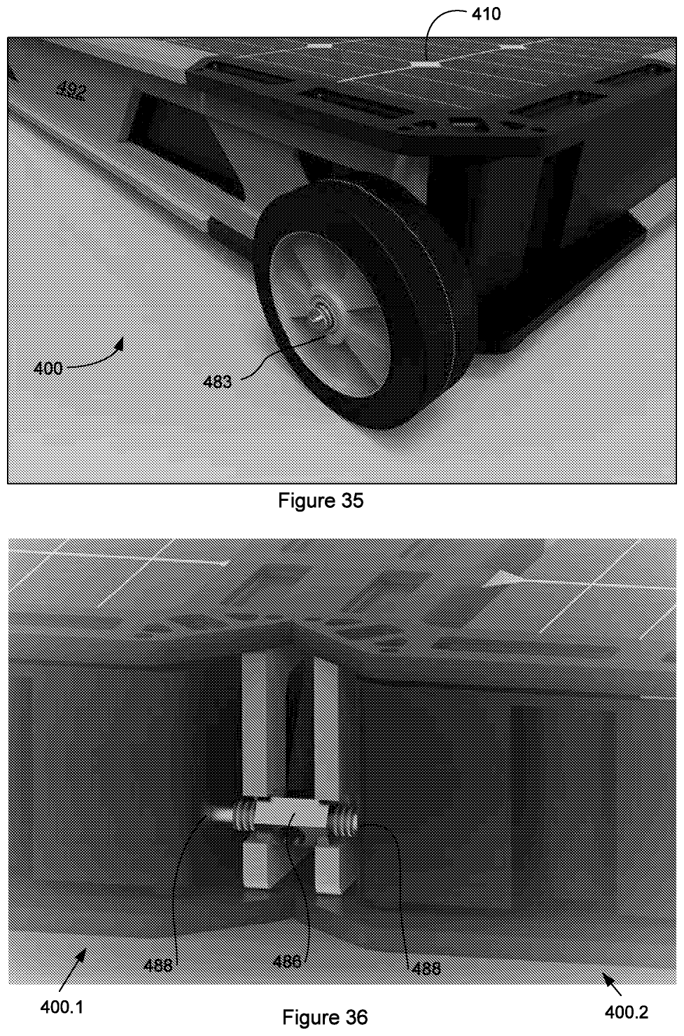

The enlarged fragmented view of a corner of the module 400 in FIG. 35 shows a wheel 483 mounted with an axle member located in side recess 488, which wheels in the present embodiment serves a dual purpose for ease of relocation of individual modules.

A further enlarged fragments view of a pair of interconnected modules 400.1, 400.2 is illustrated in FIG. 36. A protrusion 486 in the form of a shaft having threaded ends and a central hexagonal drive portion is here employed to attach the adjacent modules to one another.

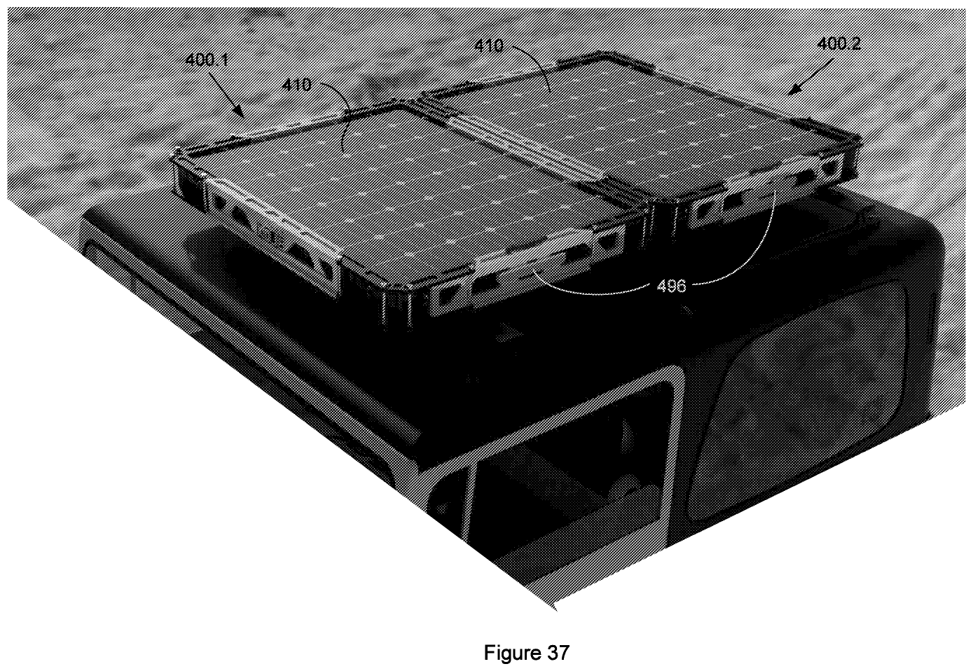

In FIG. 37, the two modules 400.1, 400.2 are shown mounted to a roof rack (not shown) of a motor vehicle. If required, the solar PV panels may be enabled to allow for charging of internal battery banks when “on the move”. Lifting handles 496 may be provided in an end face of the outer casing, as required.

The embodiments of a deployable solar generator system (“DSGS”) of the present invention can solve one or more of the aforementioned key technical problems with a solar generator module in an integrated package or product, as follows:
a) The integrated package combines all of the components for a photovoltaic generator system into a single combined product or module. This module desirably includes a photovoltaic panel, wiring, maximum power point tracker, charge controller, battery management system, battery, inverter, short-circuit and over current protection and power outlets. These components are integrated into a single, manually deployable package such that the module outputs a residential power (e.g. 240 volt in Australia) through a general purpose outlet (e.g. the female end of a conventional power cord). A DC output is also made available, for example a 5 volt USB type, 12v or even 24v. The DSGS can also come with a charging port that allows the battery to be directly charged. With these components integrated and enclosed within the single product, it is as safe and convenient to use as a petrol engine powered portable generator.
b) The DSGS module has a mounting inlet or socket and outlet for a frame protrusion to allow connection to other, adjacent DSGS modules. This means that multiple DSGS can be clicked together to form chains of modules in a multi-module DSGS. These chains of modules include electrical connections so that the power and current of multiple DSGS modules can be summed (up to a rated maximum allowable current). In one embodiment, the electrical connections are the connection of two residential power cords (i.e. a male plug and female receptacle connectors), essentially as familiar to a user as connecting two extension cords together. For safety purposes, there is a built in protection sub-system to ensure that the number of DSGS modules connected together does not exceed current carrying capacity of the wiring. This allows the DSGS to be conveniently scaleable to accommodate individual power needs and makes it easy to add or reduce capacity of the DSGS at any time.
c) The DSGS product includes a ruggedized exterior that allows it to be safety stacked and transported. The exterior houses a mounting structure that can be secured to a roof or folded out to allow field or slab installation, or in the alternative allows attachment of wheel members for ease of manual handling. As a result, a single DSGS module can be setup within minutes by one person.

### Advantageous Effects of Invention

There are several key areas of advantageous effects associated with one or more embodiments of the solar generator modules of the invention:
a) Simple: The DSGS makes photovoltaic systems within built in battery storage as simple as petrol engine powered generator that can be purchased from a local hardware store. This means that the solar generator modules can be used by an everyday person without formal training.
b) Scalable: The DSGS is entirely scalable for the application and can be added to at any time with minimal effort by simply interconnecting adjacent modules together.
c) Deployable: The DSGS can be transported through rugged terrain and setup manually within minutes. This makes solar photovoltaic energy generation technology a viable option for providing power in disaster relief efforts.

It is to be noted that positional adjectives used in this specification, such as top/bottom (or back), front/rear and right/left are used herein in relation to discussion of preferred embodiments for convenience in a relative context, and are not to be construed as limiting the particular orientation of components in or on the solar generating modules, including whether as constructed or when in use. For example, features appearing on side faces in the preferred embodiments, may instead be provided on end faces in alternative embodiments without departing from the spirit and scope of the appended claims.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A solar generator module for manual deployment, the module comprising:
at least one photovoltaic solar panel forming an array of solar cells having a perimeter;
a solar panel interface unit receiving a DC supply from the at least one solar panel;
at least one energy storage battery coupled to the interface unit;
a battery management sub-system coupled to the storage battery;
a DC-AC inverter having an input coupled to the storage battery; and
at least one protected AC outlet receptacle fed via an AC bus from an output of the DC-AC inverter;
wherein the solar panel array, interface unit, energy storage battery, battery management sub-system, inverter and AC outlet receptacle are integrated into a unitary package;
the unitary package including a rugged frame and an outer casing associated with the frame and substantially surrounding the perimeter of said array of solar cells, the casing having side faces with an engagement formation that can be releasably attached to an opposing casing side face of an adjacent solar generator module.

2. The solar generator module according to claim 1 wherein the rugged frame provides shock resistant mounting of the integrated components and the outer casing is configured to allow vertical stacking for transport and/or storage purposes.

3. The solar generator module according to claim 1 wherein the casing houses a mounting structure for supporting the solar generator module in a desired position or for manual handling.

4. The solar generator module according to claim 3 wherein the mounting structure includes adjustable legs pivotally mounted to the rugged frame, each leg including a foot adapted to be fixed to a support surface.

5. The solar generator module according to claim 3 wherein the mounting structure includes handles provided on front and/or rear faces of the outer casing.

6. The solar generator module according to claim 3 wherein the mounting structure includes wheel members or rollers provided on end or side faces of the outer casing.

7. The solar generator module according to claim 1 wherein the engagement formation includes a plurality of protrusions and/or a plurality of complementary recesses on opposing side faces of the outer casing.

8. The solar generator module according to claim 7 wherein the protrusions include a pair of tubular members and the recesses comprise sockets adapted to receive the tubular members of an adjacent solar generator module.

9. The solar generator module according to claim 7 wherein the protrusions and recesses are provided alternately in the form of castellated housing sections, wherein the castellated section on a first side face of the outer casing is complementary to the castellated section on a second side face of the outer casing.

10. The solar generator module according to claim 1 wherein faces of the outer casing include electrical connectors for electrically linking adjacent modules together.

11. The solar generator module according to claim 10 wherein electrical linking of adjacent generator modules includes provision of a common AC bus for linked modules.

12. The solar generator module according to claim 10 wherein the electrical connectors include an electrical plug and an electrical receptacle provided on first and second side faces of the outer casing, respectively.

13. The solar generator module according to claim 10 wherein the electrical connectors are provided on first and second side faces of the outer casing, with electrical cabling associated with the connectors being housed in an outer sleeve.

14. The solar generator module according to claim 13 wherein an assembly of the electrical connectors and a strong resilient outer sleeve provides electrical links between adjacent modules and assists in attaching the modules to one another.

15. The solar generator module according to claim 10 wherein operation of the interface unit, energy storage battery, battery management sub-system and inverter are coordinated by a main control unit (MCU) housed within the integrated package.

16. The solar generator module of claim 15 wherein the MCU communicates with adjacent modules via a common data bus, and said electrical connectors further including connectors for the common data bus linking the adjacent modules.

17. The solar generator module of claim 15 further including a rectifier for selectively charging the energy storage battery from the AC bus, under control of the MCU.

18. The solar generator module of claim 15 wherein the MCU is arranged to detect electrical connection of an adjacent solar generator module and synchronise the use of the solar PV array and storage battery in the adjacent module, together with any AC voltage present on the AC bus.

19. The solar generator module of claim 18 wherein the MCU is provided with sensing lines associated with both AC bus connectors and/or data bus connectors on each of the first and second side faces of the outer casing.

20. A solar generator system comprising a plurality of linked solar generator modules according to claim 1.

21. A method for managing the use and storage of electrical energy in a deployable solar generator module according to claim 15, comprising the steps of:
detecting charge state of the at least one energy storage battery; and
charging the battery from any excess available supply from the inverter and/or from an external DC supply.

22-24. (canceled)
